(19) United States
(12) Patent Application Publication
(10) Pub. No.: US 2020/0410219 A1
(43) Pub. Date: Dec. 31, 2020

(54) MOVING OBJECT DETECTION DEVICE, CONTROL DEVICE, MOVABLE BODY, MOVING OBJECT DETECTION METHOD AND PROGRAM

(71) Applicant: SZ DJI TECHNOLOGY CO., LTD., Shenzhen (CN)

(72) Inventor: Noriyuki ARAMAKI, Shenzhen (CN)

(21) Appl. No.: 17/014,725

(22) Filed: Sep. 8, 2020

Related U.S. Application Data
(63) Continuation of application No. PCT/CN2018/121799, filed on Dec. 18, 2018.

(30) Foreign Application Priority Data
Mar. 14, 2018 (JP) 2018-046807

(51) Int. Cl. G06K 9/00; G06T 7/20; G05D 1/10

(52) U.S. Cl. CPC G06K 9/00335; G05D 1/10; G06T 7/20

(57) ABSTRACT

A moving object detection device includes a processor and a computer-readable storage medium. The computer-readable storage medium stores a program that, when executed by the processor, causes the processor to obtain a plurality of images photographed by a camera carried by a movable body, determine movement of a photographed objects based on the plurality of images, determine movement of the movable body, and detect whether the photographed object is a moving object based on the movement of the photographed object and the movement of the movable body.

### CROSS-REFERENCE TO RELATED APPLICATIONS

This application is a continuation of International Application No. PCT/CN2018/121799, filed Dec. 18, 2018, which claims priority to Japanese Application No. 2018-046807, filed Mar. 14, 2018, the entire contents of both of which are incorporated herein by reference.

### TECHNICAL FIELD

The present disclosure relates to a moving object detection device, a control device, a movable body, and a moving object detection method and program.

### BACKGROUND

Japanese Patent Application Laid-Open No. 2994170 discloses a vehicle periphery monitoring device configured to detect presence of a peripheral approaching vehicle/peripheral cutting-in vehicle in an optical flow in a same direction as the moving direction of an assumed image when the peripheral approaching vehicle/peripheral cutting-in vehicle exists.

### SUMMARY

Embodiments of the present disclosure provide a moving object detection device including a processor and a computer-readable storage medium. The computer-readable storage medium stores a program that, when executed by the processor, causes the processor to obtain a plurality of images photographed by a camera carried by a movable body, determine movement of a photographed objects based on the plurality of images, determine movement of the movable body, and detect whether the photographed object is a moving object based on the movement of the photographed object and the movement of the movable body.

Embodiments of the present disclosure provide a controller including a processor and a computer-readable storage medium. The computer-readable storage medium stores a program that, when executed by the processor, causes the processor to obtain a plurality of images photographed by a camera carried by a movable body, determine movement of a photographed objects based on the plurality of images, determine movement of the movable body, detect whether the photographed object is a moving object based on the movement of the photographed object and the movement of the movable body to obtain a detection result, and control a photographing condition of the camera based on the detection result.

Embodiments of the present disclosure provide a moving object detection method. The method includes obtaining a plurality of images photographed by a camera carried on a movable body, determining movement of a photographed object based on the plurality of images, determining movement of the movable body, and detecting whether the photographed object is a moving object based on the movement of the photographed object and the movement of the movable body.

### BRIEF DESCRIPTION OF THE DRAWINGS

FIG. 1 is a schematic diagram showing an appearance of an unmanned aerial vehicle (UAV) and a remote controller according to some embodiments of the present disclosure.

FIG. 2 is a schematic diagram showing function blocks of the UAV according to some embodiments of the present disclosure.

FIG. 3 is a schematic diagram showing an optical flow according to some embodiments of the present disclosure.

FIG. 4 is a schematic diagram showing the optical flow according to some embodiments of the present disclosure.

FIG. 5 is a schematic flowchart of a process of detecting a moving object according to some embodiments of the present disclosure.

FIG. 6 is a schematic diagram showing hardware configuration according to some embodiments of the present disclosure.

### REFERENCE NUMERALS

10 UAV
20 UAV body
30 UAV controller
31 Receiver
32 Setting circuit
33 Acquisition circuit
32 Determination circuit
35 Detection circuit
36 Communication interface
37 Storage device
40 Propeller
41 GPS receiver
42 Inertial measurement Unit (IMU)
43 Magnetic compass
44 Barometric altimeter
45 Temperature sensor
46 Humidity sensor
50 Gimbal
60 Camera device
100 Camera device
102 Imaging unit
110 Camera controller
120 Image sensor
130 Storage device
200 Lens unit
210 Lens
212 Lens driver
214 Position sensor
220 Lens controller
222 Storage device
300 Remote operation device
1200 Computer
1210 Host controller
1212 Central processing unit (CPU)
1214 Random-access memory (RAM)
1220 I/O controller
1222 Communication interface
1230 Read-only memory (ROM)

### DETAILED DESCRIPTION OF THE EMBODIMENTS

The present disclosure is described through embodiments, but following embodiments do not limit the present disclosure. Not all combinations of features described in embodiments are necessary for solutions of the present disclosure. Those of ordinary skill in the art can make various modifications or improvements to following embodiments. Such modifications or improvements are within the scope of the present disclosure.

Various embodiments of the present disclosure are described with reference to flowcharts or block diagrams. In this disclosure, a block in the figures can represent (1) an execution stage of a process of operation or (2) a functional unit of a device for operation execution. The referred stage or unit can be implemented by a programmable circuit and/or a processor. A special-purpose circuit may include a digital and/or analog hardware circuit or may include an integrated circuit (IC) and/or a discrete circuit. The programmable circuit may include a reconfigurable hardware circuit. The reconfigurable hardware circuit may include logical AND, logical OR, logical XOR, logical NAND, logical NOR, other logical operation circuits, a trigger, a register, a field-programmable gate arrays (FPGA), a programmable logic array (PLA), or another storage device.

A computer-readable medium may include any tangible device that can store commands executable by an appropriate device. The commands, stored in the computer-readable medium, can be executed to perform operations consistent with the disclosure, such as those specified according to the flowchart or the block diagram described below. The computer-readable medium may include an electronic storage medium, a magnetic storage medium, an optical storage medium, an electromagnetic storage medium, a semiconductor storage medium, etc. The computer-readable medium may include a floppy Disk®, hard drive, random access memory (RAM), read-only memory (ROM), erasable programmable read-only memory (EPROM or flash memory), electrically erasable programmable read-only memory (EEPROM), static random access memory (SRAM), compact disc read-only memory (CD-ROM), digital versatile disc (DVD), Blu-ray® disc, memory stick, integrated circuit card, etc.

A computer-readable command may include any one of source code or object code described by any combination of one or more programming languages. The source or object codes include traditional procedural programming languages. The traditional procedural programming languages can be assembly commands, command set architecture (ISA) commands, machine commands, machine-related commands, microcode, firmware commands, status setting data, or object-oriented programming languages and “C” programming languages or similar programming languages such as Smalltalk, JAVA (registered trademark), C++, etc. Computer-readable commands can be provided locally or via a wide area network (WAN) such as a local area network (LAN) or the Internet to a general-purpose computer, a special-purpose computer, or a processor or programmable circuit of other programmable data processing device. The processor or the programmable circuit can execute computer-readable commands to be a manner for performing the operations specified in the flowchart or block diagram. The example of the processor includes a computer processor, a processing unit, a microprocessor, a digital signal processor, a controller, a microcontroller, etc.

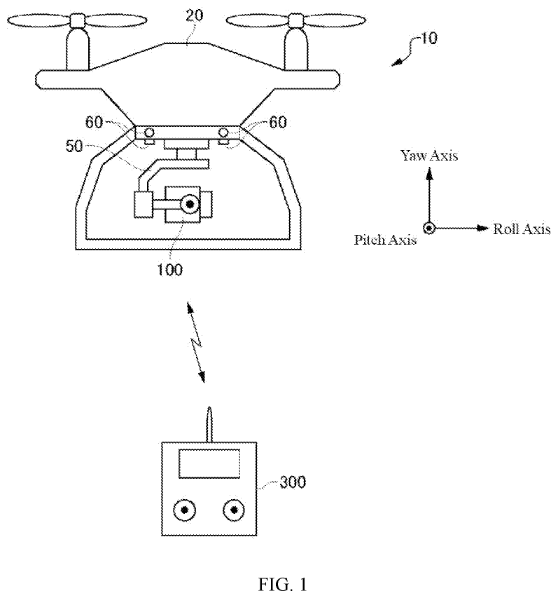

FIG. 1 illustrates an example of an appearance of an unmanned aerial vehicle (UAV) 10 and a remote operation device 300. The UAV 10 includes a UAV body 20, a gimbal 50, a plurality of camera devices 60, and a camera device 100. The gimbal 50 and the camera device 100 are an example of a camera system. The UAV 10 is a movable body, which includes an aerial vehicle capable of moving in the air, a vehicle capable of moving on the ground, a ship capable of moving on the water, etc. The aerial body moving in the air not only includes the UAV 10 but also includes other aircrafts, airships, helicopters, etc., capable of moving in the air.

The UAV body 20 includes a plurality of rotors. The plurality of rotors are an example of the propeller. The UAV body 20 controls rotations of the plurality of rotors to cause the UAV 10 to fly. The UAV body 20 uses, for example, four rotors to cause the UAV 10 to fly. The number of rotors is not limited to four. In some embodiments, the UAV 10 may also be a fixed-wing aircraft without a rotor.

The camera device 100 is an imaging camera that captures an object within a desired imaging range. The gimbal 50 can rotatably support the camera device 100. The gimbal 50 is an example of a supporting mechanism. For example, the gimbal 50 uses an actuator to rotatably support the camera device 100 on a pitch axis. The gimbal 50 uses an actuator to further support the camera device 100 rotatably by using a roll axis and a yaw axis as rotation axes. The gimbal 50 can rotate the camera device 100 around at least one of the yaw axis, the pitch axis, or the roll axis to change an attitude of the camera device 100.

The plurality of camera devices 60 are sensing cameras that sense surroundings to control flight of the UAV 10. Two of the camera devices 60 may be arranged at a head, i.e., the front, of the UAV 10. The other two camera devices 60 may be arranged at the bottom of the UAV 10. The two camera devices 60 at the front can be used in pair, which function as a stereo camera. The two camera devices 60 at the bottom may also be used in pair, which function as a stereo camera. The UAV 10 can generate three-dimensional space data for the surrounding of the UAV 10 based on images captured by the plurality of camera devices 60. The number of the camera devices 60 of the UAV 10 is not limited to four, and can be one. The UAV 10 may also include at least one camera device 60 at each of the head, tail, each side, bottom, and top. An angle of view that can be set in the camera device 60 may be larger than an angle of view that can be set in the camera device 100. The camera device 60 may include a single focus lens or a fisheye lens.

The remote operation device 300 communicates with the UAV 10 to control the UAV 10 remotely. The remote operation device 300 may communicate with the UAV 10 wirelessly. The remote operation device 300 transmits to the UAV 10 instruction information indicating various commands related to the movement of the UAV 10 such as ascent, descent, acceleration, deceleration, forward, backward, rotation, etc. The instruction information includes, for example, instruction information to ascend the UAV 10. The instruction information may indicate a desired height for the UAV 10. The UAV 10 moves to a height indicated by the instruction information received from the remote operation device 300. The instruction information may include an ascending command to ascend the UAV 10. The UAV 10 ascends when receiving the ascending command. When the UAV 10 reaches an upper limit in height, even the UAV 10 receives the ascending command, the UAV 10 may be limited from further ascending.

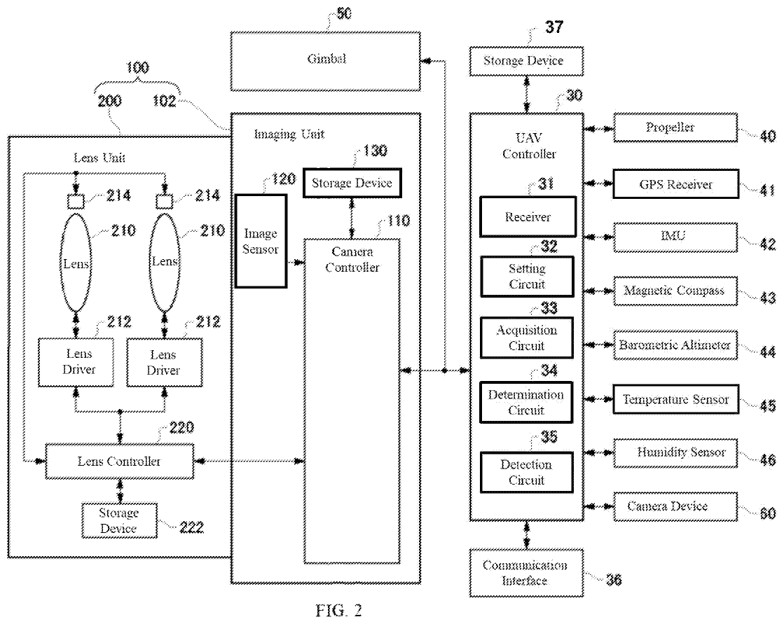

FIG. 2 illustrates an exemplary schematic diagram of a functional block of the UAV 10 according to some embodiments of the present disclosure. The UAV 10 includes a UAV controller 30, a storage device 37, a communication interface 36, a propeller 40, a global position system (GPS) receiver 41, an inertia measurement unit (IMU) 42, a magnetic compass 43, a barometric altimeter 44, a temperature sensor 45, a humidity sensor 46, the gimbal 50, the camera device 60, and the camera device 100.

The communication interface 36 communicates with the remote operation device 300 and other devices. The communication interface 36 may receive instruction information from the remote operation device 300, including various commands for the UAV controller 30. The storage device 37 stores programs needed for the UAV controller 30 to control the propeller 40, the GPS receiver 41, the IMU 42, the magnetic compass 43, the barometric altimeter 44, the temperature sensor 45, the humidity sensor 46, the gimbal 50, the camera devices 60, and the camera device 100. The storage device 32 may be a computer-readable storage medium and may include at least one of SRAM, DRAM, EPROM, EEPROM, or a USB storage drive. The storage device 32 may be detachably arranged inside the UAV body 20.

The UAV controller 30 controls the UAV 10 to fly and photograph according to the programs stored in the storage device 37. The UAV controller 30 may include a microprocessor such as a central processing unit (CPU) or a micro processing unit (MPU), a microcontroller such as a microcontroller unit (MCU), etc. The UAV controller 30 controls the UAV 10 to fly and photograph according to the commands received from the remote operation device 300 through the communication interface 36. The propeller 40 propels the UAV 10. The propeller 40 includes a plurality of rotators and a plurality of drive motors that cause the plurality of rotors to rotate. The propeller 40 causes the plurality of rotors to rotate through the plurality of drive motors to cause the UAV 10 to fly according to the commands from the UAV controller 30.

The GPS receiver 41 receives a plurality of signals indicating time transmitted from a plurality of GPS satellites. The GPS receiver 41 calculates the position (latitude and longitude) of the GPS receiver 41, i.e., the position of the UAV 10 (latitude and longitude), based on the received plurality of signals. The IMU 42 detects an attitude of the UAV 10. The IMU 42 detects accelerations of the UAV 10 in three axis directions of front and back, left and right, and up and down, and angular velocities in three axis directions of the pitch axis, roll axis, and yaw axis, as the attitude of the UAV 10. The magnetic compass 43 detects an orientation of the head of the UAV 10. The barometric altimeter 44 detects a flight altitude of the UAV 10. The barometric altimeter 44 detects an air pressure around the UAV 10, and converts the detected air pressure into an altitude to detect the altitude. The temperature sensor 45 detects a temperature around the UAV 10. The humidity sensor 46 detects humidity around the UAV 10.

The camera device 100 includes an imaging unit 102 and a lens unit 200. The lens unit 200 is an example of a lens device. The imaging unit 102 includes an image sensor 120, a camera controller 110, and a storage device 130. The image sensor 120 may be composed of a charge-coupled device (CCD) or a complementary metal-oxide-semiconductor (CMOS). The image sensor 120 captures an optical image imaged through a plurality of lenses 210, and outputs image data of the captured optical image to the camera controller 110. The camera controller 110 may be composed of a microprocessor such as a central processing unit (CPU), a micro processing unit (MPU), etc., or a microcontroller such as a microcontroller unit (MCU). The camera controller 110 can control the camera device 100 according to operation commands of the camera device 100 from the UAV controller 30. The storage device 130 may be a computer-readable storage medium and may include at least one of SRAM, DRAM, EPROM, EEPROM, or a USB flash drive. The storage device 130 stores programs required for the camera controller 110 to control the image sensor 120. The storage device 130 may be detachably arranged inside a housing of the camera device 100.

The lens unit 200 includes the plurality of lenses 210, a plurality of lens drivers 212, and a lens controller 220. The plurality of lenses 210 may function as a zoom lens, a varifocal lens, and a focus lens. At least some or all of the plurality of lenses 210 are configured to move along an optical axis. The lens unit 200 may be an interchangeable lens arranged to be detachable from the imaging unit 102. The lens driver 212 causes at least some or all of the plurality of lenses 210 to move along the optical axis through a mechanism member such as a cam ring. The lens driver 212 may include an actuator. The actuator may include a step motor. The lens controller 220 drives the lens driver 212 according to lens control commands from the imaging unit 102 to cause one or the plurality of lenses 210 to move along the optical axis through the mechanism member. The lens control commands are, for example, zoom control commands and focus control commands.

The lens unit 200 further includes a storage device 222 and a position sensor 214. The lens controller 220 controls the lens 210 to move in the direction of the optical axis through a lens driver 212 according to lens operation commands from the imaging unit 102. Some or all of the lenses 210 move along the optical axis. The lens controller 220 controls at least one of the lenses 210 to move along the optical axis to execute at least one of a zoom operation or a focus operation. The position sensor 214 detects the position of the lens 210. The position sensor 214 may detect a current zoom position or a focus position.

The lens driver 212 may include a vibration correction mechanism. The lens controller 220 can cause the lens 210 to move along the direction of the optical axis or perpendicular to the direction of the optical axis through the vibration correction mechanism to execute a vibration correction. The lens driver 212 may drive the vibration correction mechanism by a step motor to perform the vibration correction. In some embodiments, the step motor may drive the vibration correction mechanism to cause the image sensor 120 to move along the direction of the optical axis or the direction perpendicular to the direction of the optical axis to perform the vibration correction.

The storage device 222 stores control values of the plurality of lenses 210 moved by the lens drivers 212. The storage device 222 may include at least one of SRAM, DRAM, EPROM, EEPROM, or a USB storage drive.

In the above-described UAV 10, a moving object is detected from photographed objects of an image photographed by the camera device 100. The camera device 100 may control exposure, focus position, and white balance based on a detection result of the moving object. The UAV 10 may follow the moving object based on the detection result of the moving object.

In some embodiments, the UAV controller 30 includes a receiver 31, a setting circuit 32, an acquisition circuit 33, a determination circuit 34, and a detection circuit 35. The UAV controller 30 is an example of a moving object detection device for detecting the moving object.

In some embodiments, the acquisition circuit 33 is configured to obtain a plurality of images photographed by the camera device 100 carried by the UAV 10. The acquisition circuit 33 may obtain a plurality of images continuously photographed by the camera device 100. The acquisition circuit 33 may further obtain a plurality of images, which form a dynamic image, photographed by the camera device 100.

In some embodiments, the determination circuit 34 is configured to determine movement of the photographed object photographed by the camera device 100 based on the plurality of images. The determination circuit 34 determines the movement of the photographed object in the images photographed by the camera device 100. The determination circuit 34 may compare the plurality of images to determine a movement vector of the photographed object in the images as the movement of the photographed object. The determination circuit 34 may derive an optical flow based on the plurality of images to determine the movement of the photographed object. The determination circuit 34 may divide the image into a plurality of blocks to derive the movement vector according to each of the blocks to derive the optical flow. The determination circuit 34 may derive the movement vector according to each pixel of the image to derive the optical flow.

In some embodiments, the determination circuit 34 further determines movement of the UAV 10. The determination circuit 34 may determine a speed and a moving direction of the UAV 10 as the movement of the UAV 10. The determination circuit 34 may determine the movement of the UAV 10 based on the position of the UAV 10 detected by the GPS receiver 41. The determination circuit 34 may further determine the movement of the UAV 10 based on information from other sensors, such as the magnetic compass 43, inertia measurement unit (IMU) 42, etc. The determination circuit 34 may further determine a distance from the camera device 100 to the photographed object. The determination circuit 34 may derive distance information according to parallax images photographed by the camera device 100 to determine the distance to the photographed object. The determination circuit 34 may further determine the movement of the camera device 100 relative to the gimbal 50. The determination circuit 34 is an example of a first determination circuit, a second determination circuit, a third determination circuit, and a fourth determination circuit.

In some embodiments, the detection circuit 35 is configured to detect the moving object from the photographed objects in the plurality of images based on the movement of the photographed objects and the movement of the UAV 10. That is, the detection circuit 35 can detect whether a photographed object is the moving object. The detection circuit 35 assumes that the photographed objects in the plurality of images are non-moving object and derive the movement of the photographed objects in the plurality of images based on the movement of the UAV 10. The detection circuit 35 detects the moving object from the photographed objects in the plurality of images based on the derived movement of the photographed objects and the movement of the photographed objects determined by the determination circuit 34. The detection circuit 35 may detect a photographed object having derived movement different from the movement of the photographed object determined by the determination circuit 34 as the moving object. When the determination circuit 34 determines the distance to the photographed objects, the detection circuit 35 may detect the moving object from the photographed objects that are within a predetermined distance range. The detection circuit 35 may further detect, from the photographed objects in the plurality of images, a photographed object that satisfies a predetermined size requirement of a to-be-detected moving object (also referred to as a “target moving object”) as the moving object (i.e., the photographed object is the target moving object), based on the movement of the photographed objects and the movement of the movable body. The detection circuit 35 may thus detect the moving object from the photographed objects in the plurality of images based on the movement of the photographed objects, the movement of the movable body, and the movement of the camera device 100 relative to the gimbal 50.

In some embodiments, the detection circuit 35 may determine, from various movement vectors of the optical flow, a movement vector different from the movement vectors of the photographed objects derived based on the movement of the UAV 10. The detection circuit 35 may detect a photographed object corresponding to the determined movement vector as the moving object.

In some embodiments, the detection circuit 35 may determine, from the various pixels forming the image, a pixel having at least one of a direction or an amplitude of the movement vector in the optical flow different from the movement vectors derived based on the movement of the UAV 10. The detection circuit 35 determines a pixel group formed by adjacent pixels according to the determined pixel. When the number of pixels of the pixel group exceeds a predetermined threshold, the detection circuit 35 may detect the area formed by the pixel group of the image as the moving object.

In some embodiments, the detection circuit 35 may further determine, from blocks (e.g., 8×8 (pixels), 16×16 (pixels)) forming the image, a block having at least one of a direction or an amplitude of the movement vector in the optical flow different from the movement vectors derived based on the movement of the UAV 10. The detection circuit 35 may determine a block group formed by adjacent blocks from determined blocks. When a number of pixels of the block group exceeds a predetermined threshold, the detection circuit 35 may detect the area of the image formed by the block group as the moving object.

In some embodiments, the receiver 31 is configured to receive the size of the to-be-detected moving object. For example, the receiver 31 may receive the size of the to-be-detected moving object from the user through the remote operation device 300. The receiver 31 may receive the size of the to-be-detected moving object relative to the image photographed by the camera device 100. The receiver 31 may further receive the image dimension (pixel quantity in the horizontal direction×pixel quantity in the vertical direction) relative to the image photographed by the camera device 100 as the size of the to-be-detected moving object. In this disclosure, “pixel quantity” refers to the number of pixels.

In some embodiments, when the receiver 31 receives the image dimension relative to the image photographed by the camera device 100 as the size of the to-be-detected moving object, the image dimension relative to the image may change according to the distance from the camera device 100 to the moving object. Therefore, when the distance from the to-be-detected moving object to the camera device 100 and the size of the moving object are predetermined, the receiver 31 may receive the size of the to-be-detected moving object through the image dimension relative to the image. In other embodiments, the actual size of the moving object may be arbitrary. When a ratio of the moving object relative to the image is predetermined, the receiver 31 may receive the size of the to-be-detected moving object through the image dimension relative to the image.

In some embodiments, the receiver 31 may further receive the actual size of the to-be-detected moving object. The receiver 31 may receive at least one of a width or height of the to-be-detected moving object as the actual size of the to-be-detected moving object. After the detection circuit 35 detects the distance to the photographed object as a candidate of the moving object, the actual size of the to-be-detected moving object may be converted to the image dimension relative to the image according to the distance.

In some embodiments, the setting circuit 32 sets a size condition for the to-be-detected moving object based on the size of the to-be-detected moving object received by the receiver 31. The setting circuit 32 may set a pixel quantity of a smallest image dimension that can be used by the detection circuit 35 to detect a photographed object as a moving object, as the size condition of the to-be-detected moving object. The pixel quantity may be used as a threshold for the detection circuit 35 to detect the moving object from the photographed objects.

In some embodiments, the camera controller 110 may control photographing condition of the camera device based on the detection result of the moving object detected by the detection circuit 35. The camera controller 110 may control at least one of the photographing conditions including exposure, focus position, or white balance. The camera controller 110 may further control at least one condition of exposure, focus position, or the white balance based on the area determined by the detection result of the moving object detected by the detection circuit 35. The camera controller 110 may perform automatic exposure processing based on the determined area. The camera controller 110 may further perform automatic focus processing to focus on the determined area. The camera controller 110 may perform automatic white balance processing by determining a light source in the area and deriving a white balance correction value corresponding to the light source.

In some embodiments, the UAV controller 30 may control the flight of the UAV 10 to follow the moving object based on the detection result of the moving object detected by the detection circuit 35.

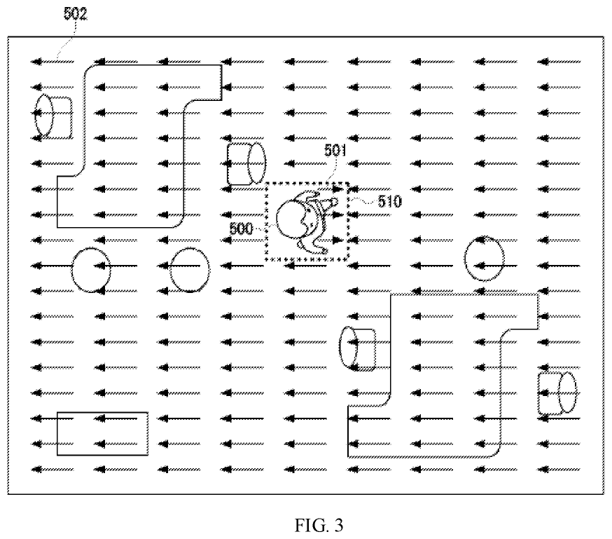

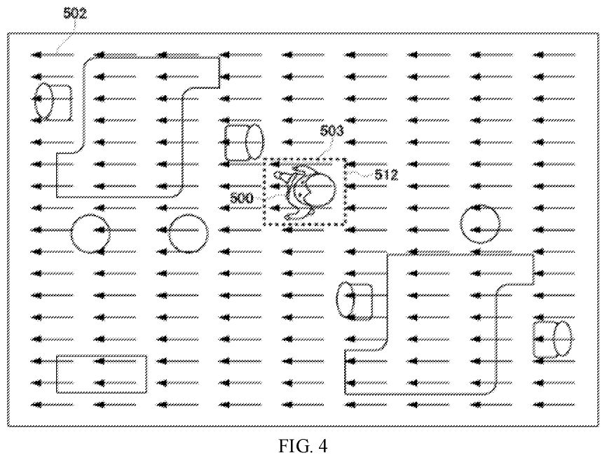

FIG. 3 and FIG. 4 illustrate an example of the optical flow. The optical flow shown in FIG. 3 and FIG. 4 is an example of an optical flow derived from the plurality of images photographed by the camera device 100 facing downward during the flight of the UAV 10. That is, the optical flow shown in FIG. 3 and FIG. 4 is an example of an optical flow derived from the plurality of images photographed by the camera device 100 towards a camera direction with a vertical downward component during the flight of the UAV 10.

As shown in FIG. 3, when a person 500 as a moving object moves in a direction same as a moving direction of the UAV 10 at a speed different from that of the UAV 10, the movement vector 501 of the person 500 has a direction and amplitude different from those of the other movement vectors 502 in the optical flow. The detection circuit 35 detects the collection of the pixels having such movement vector 501 as the moving object. For example, the detection circuit 35 detects a photographed object in a rectangular area 510 as the moving object.

As shown in FIG. 4, when the person 500 as the moving object moves in a direction opposite to the moving direction of the UAV 10, the amplitude of a movement vector 503 of the person 500 is different from the amplitudes of the other movement vectors in the optical flow. The detection circuit 35 detects a collection of pixels having the movement vector 503 as the moving object. For example, the detection circuit 35 detects a photographed object of a rectangular area 512 as the moving object.

As described above, the detection circuit 35 is configured to take into consideration the optical flow derived from the plurality of images photographed by the camera device 100 and the movement of the UAV 10, and determine, from the movement vectors in the optical flow, the movement vector having at least one of the amplitude or direction different from those of the movement vectors caused by the movement of the UAV 10, to detect the moving object from the photographed objects in the plurality of images. When the size of the to-be-detected moving object is predetermined, the detection circuit 35 may effectively determine the movement vector corresponding to the to-be-detected moving object from the plurality of movement vectors in the optical flow and detect the moving object.

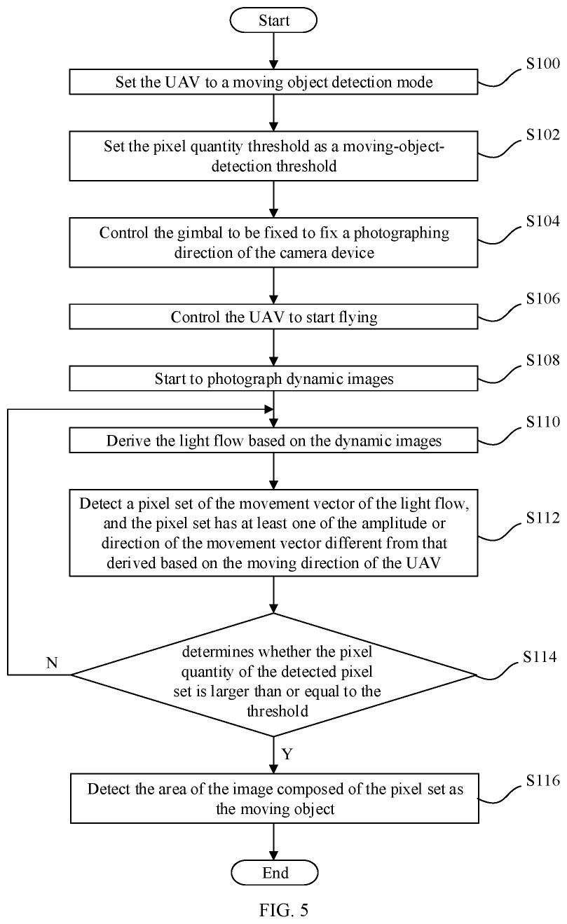

FIG. 5 illustrates a schematic flowchart of a method of detecting a moving object according to some embodiments of the present disclosure. The UAV controller 30 sets the UAV 10 to a moving object detection mode (S100). The receiver 31 receives a pixel quantity threshold corresponding to the size of the to-be-detected object from the user, and the setting circuit 32 sets the pixel quantity threshold as a moving-object-detection threshold (S102). The UAV controller 30 controls the gimbal 50 to be fixed to fix a photographing direction of the camera device 100 (S104). For example, after controlling the gimbal 50 to cause the photographing direction of the camera device 100 vertically downward, the UAV controller 30 controls the gimbal 50 to be fixed to maintain the photographing direction of the camera device 100. The UAV controller 30 controls the UAV 10 to start flying (S106).

In some embodiments, when the images photographed by the camera device 100 include a photographed object at infinity, among the movement vectors of the optical flow, there may be a movement vector that almost does not include a movement vector component following the movement of the UAV 10. When such the movement vector exists, the detection circuit 35 may not be able to accurately detect the moving object. Therefore, the UAV controller 30 may control the gimbal to cause the photographing direction of the camera device 100 to be vertically downward and control the flight of the UAV 10 to cause the height of the UAV 10 to be maintained within a predetermined height to the ground. The UAV controller 30 may control the flight of the UAV 10 to cause the distance to the farthest photographed object (background) photographed by the camera device 100 to be maintained within a predetermined distance. For example, the UAV controller 30 may control the flight of the UAV 10 to cause a distance from the wall in the photographing direction of the camera device 100 to the UAV 10 to be maintained within the predetermined distance.

During the flight of the UAV 10, the camera device 100 starts to photograph dynamic images (S108). The determination circuit 34 derives the optical flow based on the dynamic images (S110). The detection circuit 35 detects a pixel set of the movement vector of the optical flow, and the pixel set has at least one of the amplitude or direction of the movement vector different from that derived based on the moving direction of the UAV 10 (S112). The detection circuit 35 determines whether the pixel quantity of the detected pixel set is larger than or equal to the threshold (S114). When the pixel quantity of the detected pixel set is not larger than or equal to the threshold, the UAV controller 30 repeats the processes after process S110.

On the other hand, when the pixel quantity of the detected pixel set is larger than or equal to the threshold, the detection circuit 35 detects the area of the image composed of the pixel set as the moving object (S116).

In some embodiments, the detection circuit 35 may determine the movement vector having at least one of the amplitude or direction different from that of the movement vector of the movement of the UAV 10 from the movement vectors in the optical flow, such that the moving object of the desired size may be detected from the photographed objects in the plurality of images. Therefore, without predetermining the movement of the moving object, the moving object may be accurately detected from the photographed objects of the images photographed by the camera device 100.

In the above, an example of fixing the photographing direction of the camera device 100 by fixing the gimbal 50 is described. In a scenario that the gimbal 50 is not fixed, the detection circuit 35 may detect the moving object by considering the photographing direction of the camera device 100. In some embodiments, the detection circuit 35 may detect the pixel set. The pixel set includes the movement vector, among the movement vectors in the optical flow, that has at least one of the amplitude or direction different from the movement vector derived based on the moving direction of the UAV 10 and the moving direction of the camera device 100.

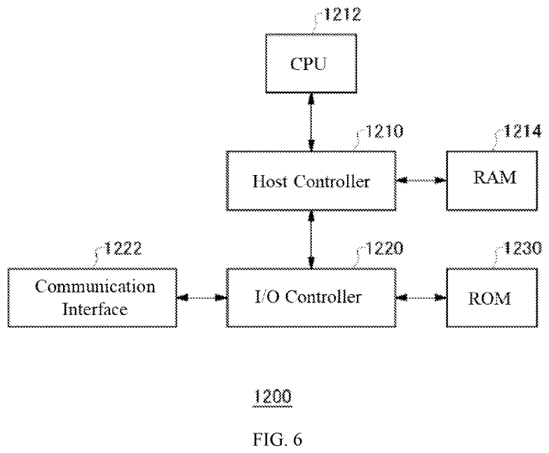

FIG. 6 illustrates a schematic diagram for describing hardware configuration according to some other embodiments of the present disclosure. Programs installed on the computer 1200 can cause the computer 1200 to function as an operation associated with a device or one or more units of the device according to embodiments of the present disclosure. In some embodiments, the program can cause the computer 1200 to implement the operation or one or more units. The program may cause the computer 1200 to implement a process or a stage of the process according to embodiments of the present disclosure. The program may be executed by a CPU 1212 to cause the computer 1200 to implement a specified operation associated with some or all blocks in the flowchart and block diagram described in the present specification.

In some embodiments, the computer 1200 includes the CPU 1212 and a RAM 1214. The CPU 1212 and the RAM 1214 are connected to each other through a host controller 1210. The computer 1200 further includes a communication interface 1222, and an I/O unit. The communication interface 1222 and the I/O unit are connected to the host controller 1210 through an I/O controller 1220. The computer 1200 further includes a ROM 1230. The CPU 1212 operates according to programs stored in the ROM 1230 and the RAM 1214 to control each of the units.

The communication interface 1222 communicates with other electronic devices through networks. A hardware driver may store the programs and data used by the CPU 1212 of the computer 1200. The ROM 1230 stores a boot program executed by the computer 1200 during operation, and/or the program dependent on the hardware of the computer 1200. The program is provided through a computer-readable storage medium such as CR-ROM, a USB storage drive, or IC card, or networks. The program is installed in the RAM 1214 or the ROM 1230, which can also be used as examples of the computer-readable storage medium, and is executed by the CPU 1212. Information processing described in the program is read by the computer 1200 to cause cooperation between the program and the above-mentioned various types of hardware resources. The computer 1200 implements information operations or processes to constitute the device or method.

For example, when the computer 1200 communicates with external devices, the CPU 1212 can execute a communication program loaded in the RAM 1214 and command the communication interface 1222 to process the communication based on the processes described in the communication program. The CPU 1212 controls the communication interface 1222 to read transmitting data in a transmitting buffer provided by a storage medium such as the RAM 1214 or the USB storage drive and transmit the read transmitting data to the networks, or write data received from the networks in a receiving buffer provided by the storage medium.

The CPU 1212 can cause the RAM 1214 to read all or needed portions of files or databases stored in an external storage medium such as a USB storage drive, and perform various types of processing to the data of the RAM 1214. Then, the CPU 1212 can write the processed data back to the external storage medium.

The CPU 1212 can store various types of information such as various types of programs, data, tables, and databases in the storage medium and process the information. For the data read from the RAM 1214, the CPU 1212 can perform the various types of processes described in the present disclosure, including various types of operations, information processing, condition judgment, conditional transfer, unconditional transfer, information retrieval/replacement, etc., specified by a command sequence of the program, and write the result back to the RAM 1214. In addition, the CPU 1212 can retrieve information in files, databases, etc., in the storage medium. For example, when the CPU 1212 stores a plurality of entries having attribute values of a first attribute associated with attribute values of a second attribute in the storage medium, the CPU 1212 can retrieve an attribute from the plurality of entries matching a condition specifying the attribute value of the first attribute, and read the attribute value of the second attribute stored in the entry. As such, the CPU 1212 obtains the attribute value of the second attribute associated with the first attribute that meets the predetermined condition.

The above-described programs or software modules may be stored on the computer 1200 or in the computer-readable storage medium near the computer 1200. The storage medium such as a hard disk drive or RAM provided in a server system connected to a dedicated communication network or Internet can be used as a computer-readable storage medium. Thus, the program can be provided to the computer 1200 through the networks.

An execution order of various processing such as actions, sequences, processes, and stages in the devices, systems, programs, and methods shown in the claims, the specifications, and the drawings, can be any order, unless otherwise specifically indicated by “before,” “in advance,” etc., and as long as an output of previous processing is not used in subsequent processing. Operation procedures in the claims, the specifications, and the drawings are described using “first,” “next,” etc., for convenience. However, it does not mean that the operating procedures must be implemented in this order.

The present disclosure is described above with reference to embodiments, but the technical scope of the present disclosure is not limited to the scope described in the above embodiments. For those skilled in the art, various changes or improvements can be made to the above-described embodiments. It is apparent that such changes or improvements are within the technical scope of the present disclosure.

What is claimed is:

1. A moving object detection device comprising:
a processor; and
a computer-readable storage medium storing a program that, when executed by the processor, causes the processor to:
obtain a plurality of images photographed by a camera carried by a movable body;
determine movement of a photographed objects based on the plurality of images;
determine movement of the movable body; and
detect whether the photographed object is a moving object based on the movement of the photographed object and the movement of the movable body.

2. The device of claim 1, wherein the program further causes the processor to:
determine a distance from the photographed object to the camera; and
determine the movement of the photographed object based on the plurality of images and the distance.

3. The device of claim 2, wherein the program further causes the processor to:
set a size condition for a target moving object; and
detect whether the photographed object satisfies the size condition based on the movement of the photographed object and the movement of the movable body to detect whether the photographed object is the target moving object.

4. The device of claim 3, wherein the program further causes the processor to:
receive a size of the target moving object relative to the plurality of images; and
set the size condition based on the size of the target moving object relative to the images.

5. The device of claim 3, wherein the program further causes the processor to:
receive an actual size of the target moving object; and
set the size condition based on the actual size of the target moving object.

6. The device of claim 3, wherein the program further causes the processor to:
receive a size of the target moving object relative to the images and an actual size of the target moving object; and
set the size condition based on the size of the target moving object relative to the images and the actual size of the target moving object.

7. The device of claim 1, wherein:
the movable body carries a support mechanism that rotatably supports the camera; and
the program further causes the processor to:
determine movement of the camera relative to the support mechanism; and
detect whether the photographed object is the moving object based on the movement of the photographed object, the movement of the movable body, and the movement of the camera.

8. A controller comprising:
a processor; and
a computer-readable storage medium storing a program that, when executed by the processor, causes the processor to:
obtain a plurality of images photographed by a camera carried by a movable body;
determine movement of a photographed objects based on the plurality of images;
determine movement of the movable body;
detect whether the photographed object is a moving object based on the movement of the photographed object and the movement of the movable body to obtain a detection result; and
control a photographing condition of the camera based on the detection result.

9. The controller of claim 8, wherein the photographing condition includes at least one of exposure, focus position, or white balance.

10. A movable body comprising:
the controller of claim 8; and
the camera.

11. The movable body of claim 10, wherein:
the movable body is an aircraft; and
the program further causes the processor to control flight of the aircraft to follow the moving object based on the detection result.

12. The movable body of claim 11, wherein the second controller controls the flight of the aircraft to cause a distance from the camera device to a photographed object to be maintained within a predetermined distance.

13. A moving object detection method comprising:
obtaining a plurality of images photographed by a camera carried on a movable body;
determining movement of a photographed object based on the plurality of images;
determining movement of the movable body; and
detecting whether the photographed object is a moving object based on the movement of the photographed object and the movement of the movable body.

14. The method of claim 13, further comprising:
determining a distance from the photographed object to the camera;
wherein determining the movement of the photographed object includes determining the movement of the photographed object based on the plurality of images and the distance.

15. The method of claim 14, further comprising:
setting a size condition for a target moving object;
wherein detecting whether the photographed object satisfies the size condition includes detecting whether the photographed object satisfies the size condition based on the movement of the photographed object and the movement of the movable body to detect whether the photographed object is the target moving object.

16. The method of claim 15, further comprising:
receiving a size of the target moving object relative to the plurality of images;
wherein setting the size condition includes setting the size condition based on the size of the target moving object relative to the images.

17. The method of claim 15, further comprising:
receiving an actual size of the target moving object;
wherein setting the size condition includes the size condition based on the actual size of the target moving object.

18. The method of claim 15, further comprising:
receiving a size of the target moving object relative to the images and an actual size of the target moving object;
wherein setting the size condition includes setting the size condition based on the size of the target moving object relative to the images and the actual size of the target moving object.

19. The method of claim 13, wherein:
the movable body carries a support mechanism that rotatably supports the camera; and
the method further includes:
determining movement of the camera relative to the support mechanism;
wherein detecting whether the photographed object is the moving object includes detecting whether the photographed object is the moving object based on the movement of the photographed object, the movement of the movable body, and the movement of the camera.

20. The method of claim 19, further comprising:
controlling the support mechanism to cause a photographing direction of the camera vertically downward.
